(19) United States
(12) Patent Application Publication
(10) Pub. No.: US 2017/0091736 A1
(43) Pub. Date: Mar. 30, 2017

(54) SECURE DEVICE

(71) Applicant: NCR Corporation, Duluth, GA (US)

(72) Inventor: David Sleeman, Dundee (GB)

(21) Appl. No.: 14/865,463

(22) Filed: Sep. 25, 2015

(51) Int. Cl. G06Q 20/18; G06Q 20/40; H04L 29/06

(52) U.S. Cl. CPC G06Q 20/18; H04L 63/0838; H04L 63/0853; H04L 63/061; H04L 63/1408; G06Q 20/4012; G06Q 2220/00

(57) ABSTRACT

Various embodiments herein each include at least one of systems, devices, methods, and software of security devices. One method embodiment includes decrypting first and second data received from first and second peripheral devices, respectively, of a Self-Service Terminal (SST) and verifying the first and second data properly originated from the first and second peripheral devices, respectively. This method may then decrypt third data received from a computer controlling operation of the SST and verifying the third data properly originated with the SST controlling computer. This method may then perform at least one remedial data processing activity when any one of the first, second, and third data are not verified as properly originated. Otherwise, when the first, second, and third data are verified as originating properly, the method includes transmitting the first, second, and third data to a transaction-processing host via a network.

### BACKGROUND INFORMATION

Increasingly consumers are conducting financial transactions through Self-Service Terminals (SSTs) without the assistance of a teller or clerk. In fact, in many cases these transactions are conducted without any individual, other than a consumer, in the vicinity of the SSTs; other than, perhaps, a security camera integrated into the SSTs or in proximity to the SSTs.

The most common SST transaction occurs by a customer at an Automated Teller Machine (ATM). Contrary to what the general public believes, ATMs can be compromised. Self-Service Checkouts (SSCs) are another form of SST and they are becoming more common. SSTs, such as ATMs and SSCs, generally include a computer that controls operation of the terminal. Such SSTs and others can be compromised through malware present on the computer. Malware may reach an SST computer in any number of ways. While there are other solutions to prevent introduction of malware to SST computers, no solution is perfect.

### SUMMARY

Various embodiments herein each include at least one of systems, devices, methods, and software of security devices, such as security devices that mitigate compromising of SSTs by malware.

One embodiment, in the form of a method that may be performed by a physical or logical secure device of an SST includes decrypting first and second data received from first and second peripheral devices, respectively, of the SST and verifying the first and second data properly originated from the first and second peripheral devices, respectively. This method may then decrypt third data received from a computer controlling operation of the SST and verifying the third data properly originated with the SST controlling computer. This method may then perform at least one remedial data processing activity when any one of the first, second, and third data are not verified as properly originated. Otherwise, when the first, second, and third data are verified as originating properly, the method includes transmitting the first, second, and third data to a transaction-processing host via a network.

Another method embodiment includes receiving card data from a card reader device via a first device interconnect and verifying the card data was received from the card reader device. When the card data is verified to have been received from the card reader device, the method provides the card data to an SST controlling computer via a second device interconnect. This method further includes receiving Personal Identification Number (PIN) data from an Encrypting PIN Pad (EPP) device via a third device interconnect and verifying the PIN data was received from the EPP device. When the PIN data is verified to have been received from the EPP device, the method includes providing the PIN data to a SST controlling computer via the second device interconnect. Additionally, this method includes receiving an SST request from the SST controlling computer via a fourth device interconnect for transmission to a transaction-processing host and verifying the SST request was received from SST controlling computer. When the SST request is verified to have been received from the SST controlling computer, the method transmits the SST request via a network interface device over a network to the transaction-processing host. However, when any of the verifying operations fails, performing at least one remedial data processing activity.

A further embodiment is in the form of a secure device. The secure device, in such embodiments, includes first and second device interconnects, a network interface device, a microprocessor, and a memory storing instructions executable by the at least one processor to perform data processing activities. The data processing activities, in some embodiments, include receiving first data from a first peripheral device via the first device interconnect and verifying the first data was received from the first peripheral device. When the first data is verified to have been received from the first peripheral device, the data processing activities include providing the first data to an SST controlling computer via the second device interconnect. The data processing activities may then receive an SST request from the SST controlling computer via the second device interconnect for transmission to a transaction-processing host. The SST request is then verified as having been received from the SST controlling computer. When the SST request is verified as having been received from the SST controlling computer, that data processing activities include transmit the SST request via the network interface device over a network to the transaction-processing host. However, when either verifying operation of the data processing activities fail, that data processing activities include performing at least one remedial data processing activity.

### BRIEF DESCRIPTION OF THE DRAWINGS

FIG. 1 is a logical block diagram of a system architecture, according to an example embodiment.

FIG. 2 is a logical block diagram of a secure device, according to an example embodiment.

FIG. 3 is a block flow diagram of a method, according to an example embodiment.

FIG. 4 is a block flow diagram of a method, according to an example embodiment.

### DETAILED DESCRIPTION

Various embodiments herein each include at least one of systems, devices, methods, and software of security devices, such as security devices that mitigate compromising of SSTs by malware. The security device, in various embodiments, may be a physical or logical device present on an SST. In a physical embodiment, the security device is installed between a computer that controls operation of the SST and at least secure devices (e.g., card reader, PIN pad, and currency dispenser devices) and a network connection over which communications with a transaction-processing are conducted. The secure device is somewhat in the form of a hub and is able to confirm that received data is received from a source from which certain data is to be received. In some such embodiments, the secure device decrypts, encrypts, and may even re-encrypt data in certain circumstances according to asynchronous encryption key pairs established between the secure device and the other devices and, in some embodiments, between the secure device and the transaction-processing host. Such embodiments are able to identify data that originates from a compromised SST source, such as in malware, rather than a source from which certain communications are normally received. For example, if a currency dispense command for a currency dispenser is received from a computer controlling operation of the SST rather than from a transaction-processing host, in the very least, the secure device is able to identify that the command originated from an improper source and can prevent the currency dispense command from reaching the currency dispenser. In some embodiments, the currency dispensed command should be received in an encrypted form and will be decrypted according to a key that only the proper source of the communication possesses. Thus, decrypting a currency dispense command that originated from an improper source will not properly decrypt the command. As such, the secure device has a second level of verification in such embodiments.

In some embodiments, the secure device may also keep a record of activities that have occurred within a transaction, as may be detected in data as initiating with data received from a card reading device and terminating upon another data event, such as upon receipt of a currency dispense command that is provided to a currency dispenser. In some such embodiments, the secure device stores data representative of sequences of such data events that are acceptable or normal, such as a card read data from a card reader device, PIN data received from a PIN pad device, and currency dispense request from an SST computer followed by a currency dispense command received form a transaction processing host. When a data event is received out of order, or without an expected precursor data event, the secure device determines the current transaction includes unexpected activities and the SST is determined to have possibly been compromised. As such, the secure device is able to take remedial action to prevent fraudulent activity from transpiring.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

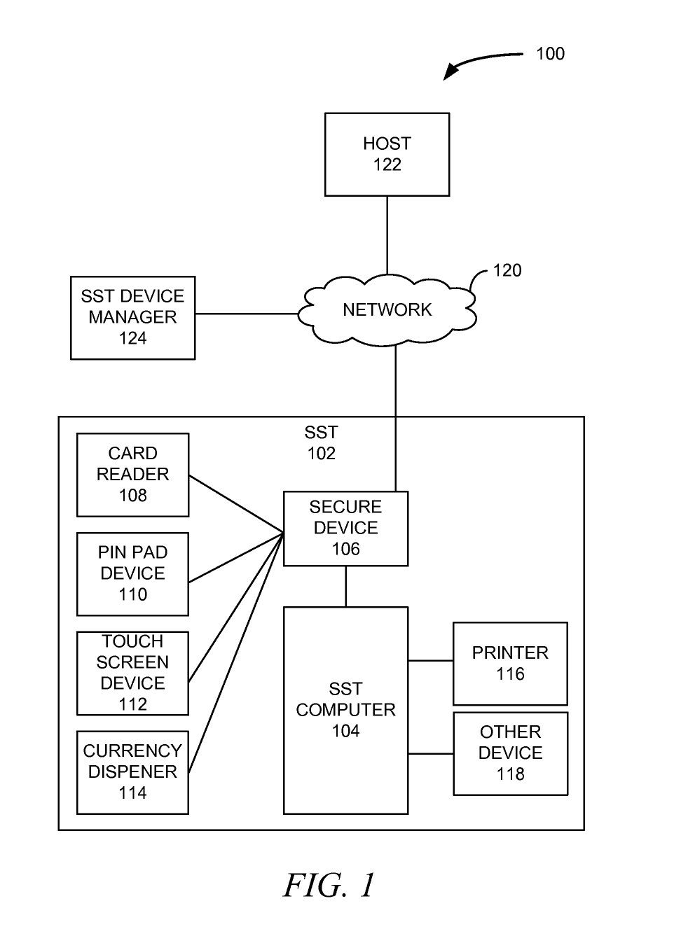

FIG. 1 is a logical block diagram of a system 100 architecture, according to an example embodiment. The system 100 includes an SST 102, a host 122, and an SST device manager 124. In various embodiments, the SST 102 may be an ATM, an SSC, a pay-at-the-pump terminal coupled to a fuel pump, a vending machine point-of-sale terminal, and other such SSTs.

The SST 102 is connected via a network 120 to the host 122. The network connecting the SST 102 to the host 122 is a network capable of carrying data between the SST 102 and the host 122. Depending on the type of SST 102 of the particular embodiment, the data network may be in accord with one or more of statutory, regulatory, industry standard, network operator, and other policies and requirements, such as security policies and requirements.

The SST 102 is also connected via the network 120 to the SST device manager 124. However, network 120 connection between the SST 102 and the SST device manager 124, in some embodiments, is indirect via the network 120 connection to the host 122. In one such embodiment, an entity operating the host 122 is the same entity operating the SST device manager 124. Thus, when data is provided to the host 122, the data may also be provided to the SST device manager 124 or forwarded by a host 122 process, which is generally provided as one or more platform services of the SST computer 104, to the SST device manager 124. In other embodiments, a connection to the SST device manager 124 may be made via a distinct network (not illustrated). The distinct network may be the Internet or other network. For example, such a distinct network may be utilized to connect the SST 102 to the SST device manager 124 in embodiments where there are no statutory, regulatory, or industry standards governing security of data communicated there between.

The host 122, also referred to as a transaction-processing host, is one or more computer systems that operate to processes transactions conducted via the SST 102. In some embodiments, the host 122 is a banking computer system that provides SST 102 access to bank and credit accounts for processing currency withdrawals, making payments, receiving deposits and payments, and the like.

The SST device manager 124, in some embodiments, is a computer system that tracks operation of a plurality of SSTs 102. For example, the SST device manager 124 may receive messages from SSTs 102 when alert conditions are detected, such as alerts for detected instance of possible fraud, malware, tampering, and the like.

The SST 102, in the example embodiment of the system 100, includes an SST computer 104, a secure device 106 coupled to the SST computer 104, and one or more peripheral devices connected to the secure device 106, such as card reader 108, PIN pad device 110, touch screen device 112, a currency dispenser 114. The peripheral devices connected to the secure device 106 are generally devices that handle data or perform operations that need to be secure to preserve transaction processing integrity and to protect against fraud.

The SST computer 104 may be connected to other peripheral devices that handle less sensitive data or perform less sensitive operation, such as a printer 116 and other such peripheral devices 118, which may include audio output devices, non-touch screen displays, and the like. Peripheral devices connected to the SST computer 104 may be connected directly to the SST computer 104 in some embodiments. In other embodiments, the other peripheral devices 118 may be connected to a hub, which is connected to the SST computer 104.

The peripheral devices, such as the card reader 108, PIN pad device 110, touch screen device 112, currency dispenser 114, and the printer 116 may be Universal Serial Bus (USB) devices and are connected accordingly. However, one or more of these peripheral devices may connect via other connection mechanisms, such as other wired or wireless technologies and connectors, which may include BLUETOOTH® and other Near-Field Communication (NFC) technologies.

In some embodiments, the secure device 106 establishes asynchronous encryption key pairs with each of the peripheral devices connected thereto. The secure device 106 also establishes an asynchronous encryption key pair with the SST computer 104. In some embodiments, each respective peripheral device 108, 110, 112, 114 and the SST computer 104 is connected to a port or via a communication channel that is registered within the secure device 106. The secure device 106 is thus able to verify when a communication from a respective peripheral device 108, 110, 112, 114 is received via the registered communication means and to verify the communications are properly encrypted as secure device 106 will attempt to decrypt received communications. Through such processing in such embodiments, the secure device 106 is able to verify a received communication has been received via a proper communication channel and that the data has been properly received in an untampered form. If either verification fails, the secure device 106 is able to stop a current transaction to thwart a possible attack on the SST 102.

In some embodiments, communications between the SST computer 104 and the host 122 are conducted through the secure device 106. In such embodiments, the secure device 106 also establishes an asynchronous encryption key pair with the host 122 and communications between the secure device 106 and the host 122 are conducted via a network interface device of the secure device 106. As such, similar verification processing may be performed on communications between the secure device 106 and the host 122.

In some embodiments, the secure device 106 may also keep a record of activities that have occurred within a transaction, as may be detected in data as initiating with data received from a card reader 108 and terminating upon another data event, such as upon receipt of a currency dispense command that is provided to a currency dispenser 114. In some such embodiments, the secure device 106 stores data representative of sequences of such data events that are acceptable or normal. For example, a card read data from the card reader 108, PIN data received from a the PIN pad device 110, and a currency dispense request from the SST computer 104 followed by a currency dispense command received form the host 122. When a data event is received out of order, or without an expected precursor data event, the secure device 106 determines the current transaction includes unexpected activities and the SST 102 is determined to have possibly been compromised. As such, the secure device 106 is able to take remedial action to prevent fraudulent activity from transpiring.

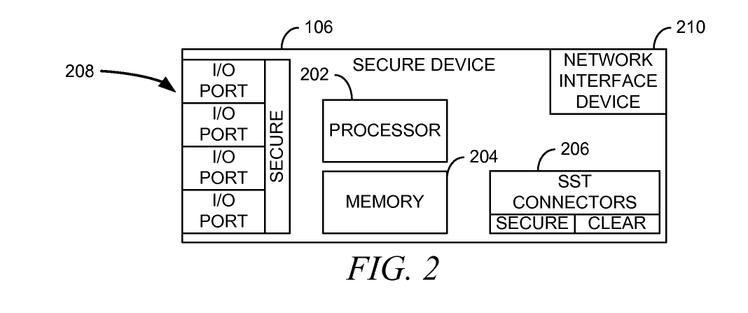

Further detail of the secure device 106 is illustrated in FIG. 2.

FIG. 2 is a logical block diagram of a secure device 106, according to an example embodiment. The secure device 106 may take the form of an integrated circuit board, an enclosed device, or other form factor. However, in some embodiments the secure device 106 may instead be integrated within or otherwise coupled to a motherboard of the SST computer 104, within a housing of a peripheral device such as a touch screen or PIN pad, or integrated with an integrated circuit board of such a peripheral device. In some embodiments, the secure device is a standalone device encased in a tamper-sensitive house and is coupled to the SST computer 104, SST 102 peripheral devices, and the network 120.

In some embodiments, the secure device 106 includes an SST connector 206, such as a Universal Serial Bus (USB) connector, a set of connector pins that plug into a dedicated or universal peripheral device slot on a motherboard of the SST computer 104, serial connector, or other connector to enable the secure device 106 to communicate data with the SST computer 104. In some embodiments, the SST connector 206 includes two sets of connectors, one secure and one clear of security, such as may be utilized for non-secure data processing tasks and the like. However, in other embodiments, the SST connector 206 includes only a secure connector.

The secure device 106 also includes a processor 204 and a memory 206. The processor 204 may be a general-purpose data processing unit, a microprocessor, one or more integrated circuits dedicated to specific tasks such as encryption, an ASIC, or other device capable of performing data processing tasks including at least one of encryption and decryption tasks depending on the particular embodiment.

The secure device 106 includes a memory 206. The memory 206 may be a volatile or non-volatile memory. For example, the memory 206 may be random access memory, flash memory, write-once memory, or of another memory type. The memory 206 may also be more than one memory device where each memory device may be of the same type of memory or varied memory types. In some embodiments, the memory 206 is a secure memory that encrypts all data therein. In other embodiments, the memory 206 may be two or more memory device. When the memory 206 includes two or more memory devices, one or more of the memory devices are secure memories in some embodiments.

The memory 206 stores instructions executable by the processor 204 to perform data processing activities, including encryption and decryption tasks based on an asynchronous encryption key pairs established by the secure device 106 with other devices, such as SST peripheral devices that may be connected to secure I/O ports 208, the SST controlling computer 104, and the host 122, in some embodiments.

The I/O ports 208 may each be of one or more connection technologies, such as wired and wireless technologies. The wired technologies may include USB, serial, proprietary, and others. The wireless technologies may be BLUETOOTH® and other NFC communication technologies.

The secure device 106 also includes a network interface device 210. In some embodiments, the network interface device 210 is a wired Ethernet network interface device. In other embodiments, the network interface device may be one or more devices, which may include WI-FI® or 3G, 4G, or other wireless standard-compliant technology device.

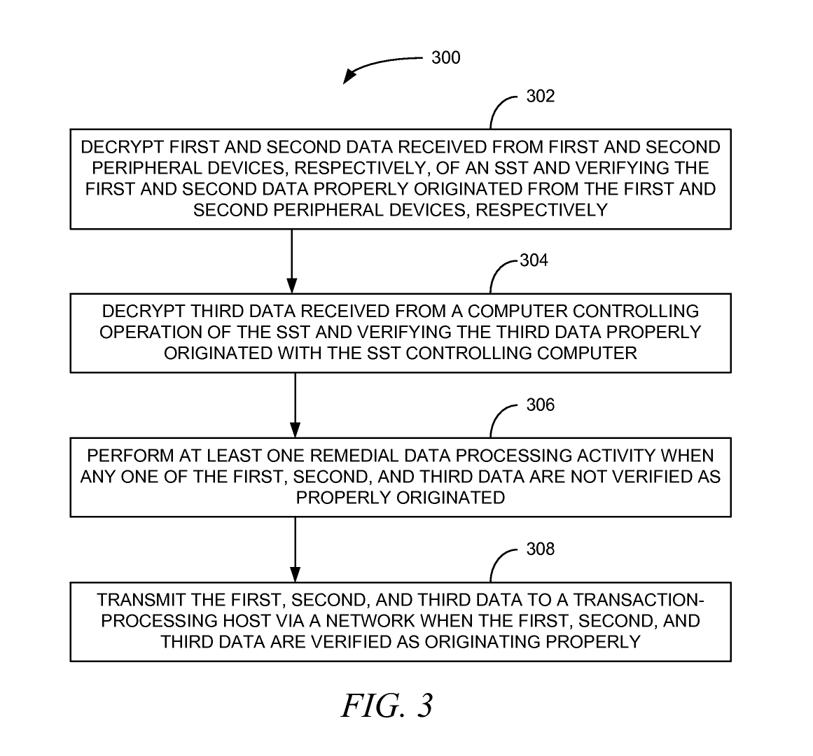

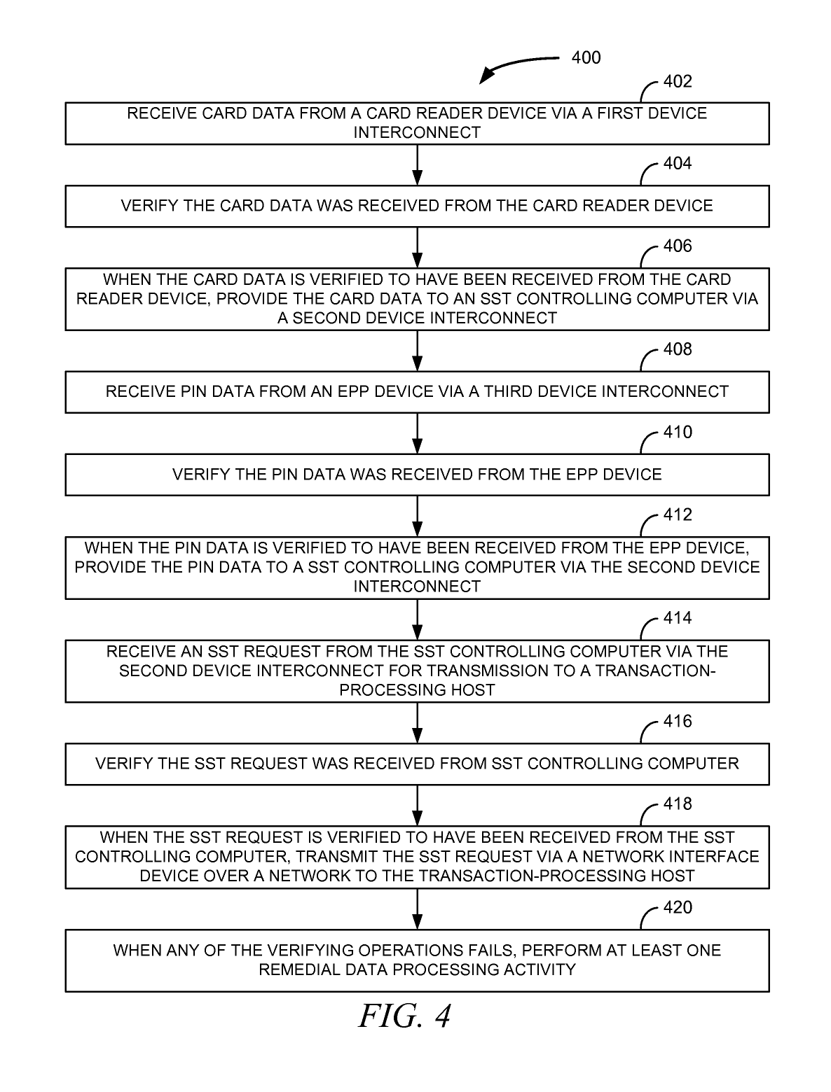

Further details on the operation of the secure device 106 when deployed within an SST, such as SST 102 of FIG. 1, are illustrated and described with regard to some embodiments in FIG. 3 and FIG. 4.

FIG. 3 is a block flow diagram of a method 300, according to an example embodiment. The method 300 is an example of a method that may be performed by a secure device, such as secure device 106 of FIG. 1 and FIG. 2.

The method 300 includes decrypting 302 first and second data received from first and second peripheral devices, respectively, of an SST and verifying the first and second data properly originated from the first and second peripheral devices, respectively. The method 300 then decrypts 304 third data received from a computer controlling operation of the SST and verifying the third data properly originated with the SST controlling computer. When any one of the first, second, and third data are not verified as properly originated, the method 300 performs 306 at least one remedial data processing activity. However, when the first, second, and third data are verified as originating properly, the method 300 includes transmitting the first, second, and third data to a transaction-processing host via a network.

In some such embodiments, of the method 300, the first peripheral device is a card reader device and the first data is data includes data read from a bank card by the card reader device. Further, the second peripheral device may be an EPP device and the second data may be data representative of a PIN received as input by the EPP device. In such embodiments, the third data received form the computer controlling operation of the SST may be a currency withdrawal request to be transmitted to a transaction-processing host for approval. In such embodiments, the method operates to verify the card data was properly received from the card reader device, the PIN number from the EPP, and the currency withdrawal request from the SST controlling computer, and perhaps even a proper specific process therein. When any of the verifications are not successful, the method 300 performs 306 at least one remedial data processing activity, such as canceling the transaction and sending an alert message via the network.

In some embodiments, when the first and second data are verified as properly originated, such as from the card reader and the EPP, the method 300 includes transmitting the decrypted first and second data to the SST controlling computer.

Transmitting the first, second, and third data to the transaction-processing host in some embodiments of the method 300 includes encrypting, prior to the transmitting, the previously decrypted first, second, and third data according to an asynchronous encryption key pair established between the secure device and the transaction-processing host. Some such embodiments also include receiving response data from the transaction-processing host in response to the transmitting of the first, second, and third data. The method 300 in such embodiments then verifies the response data was received form the transaction-processing host, which may include decrypting the response data when it is encrypted. When this verification fails, the at least one remedial data processing action is then performed 306. However, when the response data is verified as received from the transaction-processing host, such embodiments then route the response data to an intended destination, such as a currency dispenser when the transmitting of the first, second and third data included a currency withdrawal request.

FIG. 4 is a block flow diagram of a method 400, according to an example embodiment. The method 400 is another example of a method that may be performed by a secure device, such as secure device 106 of FIG. 1 and FIG. 2.

The method 400 includes receiving 402 card data from a card reader device via a first device interconnect and verifying 404 the card data was received from the card reader device. When the card data is verified to have been received from the card reader device, the method 400 includes providing 406 the card data to an SST controlling computer via a second device interconnect.

The method 400 further includes receiving 408 PIN data from an EPP device via a third device interconnect and verifying 410 the PIN data was received from the EPP device. When the PIN data is verified to have been received from the EPP device, the method 400 provides 412 the PIN data to a SST controlling computer via the second device interconnect.

The method 400 also includes receiving 414 an SST request from the SST controlling computer via the second device interconnect for transmission to a transaction-processing host and verifying 416 the SST request was received from SST controlling computer. When the SST request is verified to have been received from the SST controlling computer, the method 400 includes transmitting 418 the SST request via a network interface device over a network to the transaction-processing host.

In the method 400, when any of the verifying operations fails, the method 400 includes performing 420 at least one remedial data processing activity.

In some embodiments of the method 400, verifying 404 the card data was received from the card reader device includes verifying the card data was received via one of device interconnects and decrypting the card data with an asynchronous encryption key pair established with the card reader device. Similarly, verifying 410 PIN data was received from the EPP device in some embodiments of the method 400 includes verifying the PIN data was received via one of device interconnects and decrypting the PIN data with an asynchronous encryption key pair established with the EPP device. Further, verifying 416 the SST request was received from the SST controlling computer in some embodiments of the method 400 includes verifying the SST request was received via the second device interconnect and decrypting the SST request with an asynchronous encryption key pair established with the SST controlling computer.

In some embodiments of the method 400, only a portion of each of the received card data, PIN data, and SST request are encrypted and decrypted to perform source verification. For example, an encrypted portion of data may be added to a defined area of the data and is decrypted therefrom.

In a further embodiment, the method 400 also includes receiving response data via the network interface device from the transaction-processing host in response to the transmitted 418 SST request and verifying the response data was received form the transaction-processing host. Such an embodiment may then route the response data to an intended destination when the response data is verified as received from the transaction-processing host. However, when the response data is not verified as received from the transaction-processing host, the at least one remedial data processing activity is performed. In some such embodiments, transmitting 418 the SST request via the network interface device over the network to the transaction-processing host includes encrypting at least a portion of the SST request according to an asynchronous encryption key pair established with the transaction-processing host.

Another embodiment is in the form of an SST. The SST of such embodiments includes a controller operable to control devices within the SST, a secure device coupled to the controller, and a token reader device operable to send customer information to the controller via the secure device. The token reader device may be one or more of a card reader, a biometric reader (e.g., fingerprint scanner, iris scanner, facial recognition camera and associated software, and the like). The SST also typically includes an encrypting device operable to send an encrypted PIN to the controller via the secure device. The encrypting device may be an EPP, an encrypting touch screen, or other device. The SST further includes a media dispenser device operable to dispense media in response to a command from the controller received via the secure device. The media dispenser may be one or more of a currency dispenser, a currency recycler, a ticket or voucher dispenser that may dispense preprinted media or print tickets and vouchers on demand, a postage dispenser, and the like. The secure device in some such embodiments is operable to encrypt and decrypt communications with the token reader device, the encrypting device, and the media dispenser device. In various of such embodiments, the secure device is operable to block a dispense command when a portion of a transaction does not fulfill an acceptance criterion, such as within network traffic between the SST and a remote host monitored by the secure device. The acceptance criterion may include one or more of a transaction approval request from the remote host, the token reader device communicating customer details, the encrypting device communicating an encrypted code such as a PIN, a transaction request from the controller to the remote host, and other transaction data elements.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method of processing a transaction on a Self-Service Terminal (SST), the method comprising:
decrypting first and second data received from first and second peripheral devices, respectively, of the SST and verifying the first and second data properly originated from the first and second peripheral devices, respectively;
decrypting third data received from a computer controlling operation of the SST and verifying the third data properly originated with the SST controlling computer;
performing at least one remedial data processing activity when any one of the first, second, and third data are not verified as properly originated; and
transmitting the first, second, and third data to a transaction-processing host via a network when the first, second, and third data are verified as originating properly.

2. The method of claim 1, wherein:
the first peripheral device is a card reader device and the first data is data includes data read from a bank card by the card reader device; and
the second peripheral device is an Encrypting Pin Pad (EPP) device and the second data includes data representative of a Personal Identification Number (PIN) received as input by the EPP device.

3. The method of claim 1, wherein the at least one remedial data processing activity includes canceling the transaction and sending an alert message via the network.

4. The method of claim 3, further comprising:
transmitting the decrypted first and second data from a secure device performing the method to the SST controlling computer when the first and second data are verified as properly originated.

5. The method of claim 4, wherein the decrypting of the first, second, and third data are performed according to asynchronous encryption key pairs established with between the secure device and the respective first and second peripheral devices and the SST controlling computer.

6. The method of claim 5, wherein transmitting the first, second, and third data to the transaction-processing host includes encrypting, prior to the transmitting, the previously decrypted first, second, and third data according to an asynchronous encryption key pair established between the secure device and the transaction-processing host.

7. The method of claim 6, further comprising:
receiving response data from the transaction-processing host in response to the transmitting of the first, second, and third data;
verifying the response data was received form the transaction-processing host;
performing the at least one remedial data processing activity when the response data is not verified as received from the transaction-processing host; and
routing the response data to an intended destination when the response data is verified as received from the transaction-processing host.

8. The method of claim 7, wherein:
the response data includes a currency dispense command; and
the intended destination is a currency dispenser of the SST.

9. The method of claim 7, further comprising:
decrypting the response data according to the asynchronous encryption key pair established between the secure device and the transaction-processing host.

10. The method of claim 9, wherein the secure device that performs the method includes:
a first device interconnect to connect with the first peripheral device;
a second device interconnect to connect with the second peripheral device;
a third device interconnect to connect with the SST controlling computer;
a network interface device to connect to the network;
a memory device storing instructions and encryption keys; and
a microprocessor that executes instructions retrieved from the memory device to perform the method.

11. A method comprising:
receiving card data from a card reader device via a first device interconnect;
verifying the card data was received from the card reader device;
when the card data is verified to have been received from the card reader device, providing the card data to a Self-Service Terminal (SST) controlling computer via a second device interconnect;
receiving Personal Identification Number (PIN) data from an Encrypting PIN Pad (EPP) device via a third device interconnect;
verifying the PIN data was received from the EPP device;
when the PIN data is verified to have been received from the EPP device, providing the PIN data to a SST controlling computer via the second device interconnect;
receiving an SST request from the SST controlling computer via the second device interconnect for transmission to a transaction-processing host;
verifying the SST request was received from SST controlling computer;
when the SST request is verified to have been received from the SST controlling computer, transmitting the SST request via a network interface device over a network to the transaction-processing host; and
when any of the verifying operations fails, performing at least one remedial data processing activity.

12. The method of claim 11, wherein:
verifying the card data was received from the card reader device includes:
verifying the card data was received via one of device interconnects; and
decrypting the card data with an asynchronous encryption key pair established with the card reader device;
verifying PIN data was received from the EPP device includes
verifying the PIN data was received via one of device interconnects; and
decrypting the PIN data with an asynchronous encryption key pair established with the EPP device; and
verifying the SST request was received from the SST controlling computer includes:
verifying the SST request was received via the second device interconnect; and
decrypting the SST request with an asynchronous encryption key pair established with the SST controlling computer.

13. The method of claim 12, further comprising:
tracking data and an order in which the received data is received within a transaction in view of an expected order of receipt of the data;
when data is received out of order within the transaction, performing the at least one remedial action.

14. The method of claim 11, further comprising:
receiving response data via the network interface device from the transaction-processing host in response to the transmitted SST request;
verifying the response data was received form the transaction-processing host;
performing the at least one remedial data processing activity when the response data is not verified as received from the transaction-processing host; and
routing the response data to an intended destination when the response data is verified as received from the transaction-processing host.

15. The method of claim 14, wherein transmitting the SST request via the network interface device over the network to the transaction-processing host includes:
encrypting at least a portion of the SST request according to an asynchronous encryption key pair established with the transaction-processing host.

16. The method of claim 15, wherein verifying the response data was received from the transaction-processing host includes:
verifying the response data was received via the network interface device; and
decrypting at least a portion of the response data according to the asynchronous encryption key pair established with the transaction-processing host.

17. A self-service terminal (SST) comprising:
a controller operable to control devices within the SST;
a secure device coupled to the controller;
a token reader device operable to send customer information to the controller via the secure device;
an encrypting device operable to send an encrypted personal identification number (PIN) to the controller via the secure device;
a media dispenser device operable to dispense media in response to a command from the controller received via the secure device;
wherein the secure device is operable to block a dispense command when a portion of a transaction does not fulfill an acceptance criterion.

18. The SST of claim 17, wherein the secure device monitors network traffic between the SST and a remote host, and is operable to encrypt and decrypt communications with the token reader device, the encrypting device, and the media dispenser device.

19. The SST of claim 18, wherein the acceptance criterion includes a transaction approval request from the remote host.

20. The SST of claim 19, wherein the acceptance criterion further includes at least one of:
the token reader device communicating customer details;
the encrypting device communicating an encrypted code; and
a transaction request from the controller to the remote host.
